(19) United States
(12) Patent Application Publication
(10) Pub. No.: US 2009/0222916 A1
(43) Pub. Date: Sep. 3, 2009

(54) EMBEDDED PATCH MANAGEMENT

(76) Inventor: James Blaisdell, Novato, CA (US)

Correspondence Address: Beyer Law Group LLP, P.O. BOX 1687, Cupertino, CA, 95015-1687, US

(21) Appl. No.: 12/067,788

(22) PCT Filed: Sep. 21, 2006
(86) PCT No.: PCT/US06/36936

§ 371 Date: Aug. 19, 2008

Related U.S. Application Data
(60) Provisional application No. 60/720,347, filed on Sep. 22, 2005.
(60) Provisional application No. 60/774,498, filed on Feb. 17, 2006.

(51) Int. Cl. G06F 15/00; G06F 9/44

(52) U.S. Cl. 726/21; 717/168; 717/172

(57) ABSTRACT

A method, system and apparatus is provided for embedded patch management. In one embodiment, a method is provided. The method includes receiving a call to a code module. The method further includes checking a guardian stack for indications of authorization. The guardian stack is separate from an execution stack. The method also includes passing the call to an internal code module. Moreover, the method includes executing the code module.

### BACKGROUND

Networks may operate with a large number of devices. Such devices may be all of one type or of many different types, and may require different treatment. Managing updates to such devices can be a challenging problem. Between tracking of device updates for devices which are only occasionally connected, and tracking versions of different types of subscribers, the process becomes very complicated.

Networks operate in real-time. Thus, when a patch to a piece of hardware is sent, it may need to be added dynamically, rather than waiting for down cycles to allow for updates. It may be useful to provide a dynamic linking mechanism and a verification mechanism.

### BRIEF DESCRIPTION OF THE DRAWINGS

The present invention is illustrated in various exemplary embodiments and is limited in spirit and scope only by the appended claims.

FIG. 1 illustrates an embodiment of a code module.

FIG. 2 illustrates an embodiment of a code API.

FIG. 3 illustrates an alternate embodiment of a code module.

FIG. 4 illustrates an alternate embodiment of a code API.

FIG. 5 illustrates an embodiment of a system of code segments.

FIG. 6 illustrates an alternate embodiment of a system of code segments.

FIG. 7 illustrates an embodiment of a network of machines.

FIG. 8 illustrates an embodiment of a machine or computer.

FIG. 9 illustrates an embodiment of a process of executing a code segment.

FIG. 10 illustrates an alternate embodiment of a process of executing a code segment.

FIG. 11 illustrates an embodiment of a process of validating a code segment.

FIG. 12 illustrates an embodiment of a medium embodying patches.

FIG. 13 illustrates an embodiment of a process of applying a patch.

FIG. 14 illustrates an embodiment of a system for patch management.

FIG. 15 illustrates an embodiment of a circular buffer which may be used in tracking code progress.

FIG. 16 illustrates an embodiment of a data structure of entries which may be used in tracking code progress.

FIG. 17 illustrates an embodiment of a set of circular buffers which may be used in tracking code progress.

FIG. 18 illustrates an embodiment of a graph of software code.

FIG. 19 illustrates an embodiment of a process of tracking code using circular buffers.

FIG. 20 illustrates an embodiment of a process of maintaining and using a graph of software code.

Like reference symbols in the various drawings indicate like elements.

### DETAILED DESCRIPTION

The present invention is described and illustrated in conjunction with various systems, apparatuses and methods. In addition to the aspects of the present invention described in this summary, further aspects of the invention will become apparent by reference to the drawings and by reading the detailed description that follows.

Software patches and other code segments may be implemented in a variety of ways. By providing a guardian layer to methods, procedures and functions, code may be made more secure. In one embodiment, a guardian layer is provided as a wrap around an object or code portion, which presents an interface with the outside world, and may be used to filter out access from unauthorized sources. This can be particularly useful with patches to code, which may or may not come from trusted sources. Thus, when patches are distributed, an accompanying guardian layer for code of the patches can help provide security in the process.

A patch management system may include several standard-based components: a notification system; patch delivery protocol; patch extraction; and finally apply patch.

There are many options for sending a notification from a central point to many other network points. For a diverse customer-base, a robust protocol that will work in home networks, public cafes, enterprises, as well as the unsheltered wild Internet may be useful. Based on such criteria, the solution is preferably TCP/IP-based to avoid firewalls and NATs interference, and the end-point devices preferably connect to a central distribution server.

Two standards-based protocols (many more exist) that should work well for patch notifications are SIP (session initiation protocol, a protocol used for notifying and maintaining a VoIP phone call), and Jabber/XMMP (instant messaging protocol). SIP normally runs over UDP, but can be made to run over TCP/IP. Either protocol can be tunneled over SSL.

BitTorrent (BT) is currently the most popular protocol on the Internet, out weighing email and HTTP traffic. BitTorrent is great for delivering large file images (e.g. DVDs), and delivering the image to many, many peers (XX,000s simultaneous downloads). BitTorrent typically runs over HTTP, which makes it easy to integrate and use with a web browser. However, for embedded device applications there is no technical need to run BT over HTTP. BT protocol messaging is very similar to HTTP, but could be easily packetize for easier processing, and faster performance.

A binary version of the BT protocol, (an embedded BitTorrent) may be preferable, as it will be smaller and faster than the typical BT used with browsers today, and will not require HTTP. This may avoid any extraneous message processing, since this tends to lead to attacks and exploits, along with lots of additional code and CPU processing.

It may be useful to throttle back announcements (of patches), if customer's devices run exclusively behind NATs or firewalls, which block incoming BitTorrent client connections. Alternatively, to BT and SIP, would be to use Jabber.

Patches and firmware images are cryptographically protected to prevent tampering in transit in some embodiments. Patches are enclosed in a digitally secure envelope (PKCS #7/12). Optionally, the patches are encrypted to prevent outsider inspection of a patch. All of this comes essentially free from PKCS #7/12. The payload of the PKCS message contains meta-data describing the patch/firmware image. Meta-data contains version number information, and cross-dependencies of other objects. The meta-data may eventually contain information on how to “upgrade” dynamic data objects as well.

After a patch has been delivered and de-capsulated, it is necessary to either swap in an entire firmware image, or dynamically link the new object file replacing the previous object file from the image. There are challenges for the final version of being able to replace modules with no down time (“hot list updates”). Dynamic linking gets much closer to that point, but the C language is so flexible it works against dynamic updates. Thus, a data repository that is self-describing and map-able to future packages may be desirable.

Hot list updates support requires wrapping a layer around critical operations, such as threads, mutexes, data dictionaries, etc. Although intrusive, any modifications to the operating system and applications should be kept minimal, ideally unperceivable by the application and operating system. By leveraging the embedded linker, one can wrap critical operations by having an object code layer with the following naming convention wrap<Operation> (e.g. wrap_spawnThread). Note: At the symbol level C methods begin with an underscore.

By pre-pending a “wrap” to the symbol name, the linker will first link the wrappings call to the original operation, remove that symbol, and then rename the wrap symbol name to the original operation name. Obviously, this can be implemented in other ways to achieve the same effect.
wrap_spawnThread invokes spawnThread
linker resolves spawnThread
linker renames wrap_spawnThread to spawnThread

Application code may now unknowingly invoke wrap_spawnThread without any modifications. wrap_spawnThread, can now trace the application for purposes of doing no downtime patches, as well as monitoring an application to determine if an application is performing restricted operations. This same technique may be applied to generic object/library interfaces (APIs), for the purposes of doing code tracing. A thread profile can be created using this technique, if the thread profile goes askew (e.g. a thread illegally accesses electronic payment storage, etc), that access can be blocked. This can be implemented using a guardian layer—a wrap around an object or code portion, which provides an interface with the outside world, and may be used to filter out access from unauthorized sources.

Additionally, self-audits/integrity checks of device's object code (e.g. checking object code signatures) can be another guard, though they are most likely only affordable during system start-up. The ability to undo a patch, if a device failure occurs may be involved as well, by de-linking the new code and linking in older code.

After adding a wrapper layer for the secondary stack, hackers will attempt to peer into the wrapper code to ascertain how they might be able to jump that piece of code in real-time, or simply use a hardwired address. To prevent this sort of leap over the wall attack, each wrapper function may have junk code at the start of the wrapper code which will be random length (in terms of instructions), as well as random in result to confuse any automated worm from attempting to sniff out the true and correct original address of an API. Module order may also be in a random order to prevent the simple hardwired jump.

Code tumblers may also be implemented. These are basically code operations that cross out into other modules, but can be completed in any sort of order. Basically, one may reorder the calls to a group of modules, in a random order. This can be chained several times to add more tumblers, so that it becomes a combination of tumblers for a bigger lock with only the true code programmed with the exact combination. Thus, even if someone gets past other layers of defense the code tumbler provides another layer to defeat, while having a relatively minimal impact on performance.

Worms are persistent, so one may parry attack after attack with the various layers, but the worm could over some time slip past the guardian layers. To counter this statistical attack, one may determine what module was the original security hole into the device. An operation system may know what socket, therefore what origin IP address/port, and what port/service on the device was attacked successfully. A system can then block all traffic from that IP address or all traffic to that port, based on a predetermined policy. Such a policy can be extremely paranoid, or it can be set to trigger after a predetermined threshold number of attempts from a certain number of addresses, for example. As worms can attack from many points simultaneously, such a threshold may be particularly effective.

A patch management server includes several standard-based components: a patch builder; a patch verification system; a patch console; a notification system; and patch delivery protocol.

Only necessary interfaces are preferably exposed, and dynamically link-able. In order to determine which APIs are not required, a tool may be used which analyzes the code to look for problem areas, and to filter un-needed APIs. Doing this task by hand would be very people intensive, and prone to human error. There can literally be thousands of unused APIs in a typical device image. The tool can also determine optimal block configuration of code, which can then be tailored by hand, if necessary.

After a patch has been built, a rigorous patch verification system may be applied before a change will be accepted and sent into the field. One may extend general test network frameworks to perform automated testing on device patches. A device's internal state machine may be replicated in the test network framework, in order to test all combinations of device behavior to prevent poor patches.

The patch management server provides a console to check progress status of patches being deployed; assign customers to receive a patch (internal development, beta customers, general release, platinum customers, etc); looking for anomalies (e.g. a patch fails); and setup policies and rules for releasing patches. Once a patch has been loaded and ready to be released, a SIP (or possibly Jabber) announcement is sent to subscribed devices. The announcement message contains meta information on the patch, such as release version, other required components, and download instructions (BitTorrent, HTTPS, etc). The message may be sent over SSL to prevent eavesdropping and tampering. The announcement release may be throttled based on download protocol (BitTorrent vs HTTPS vs etc), a blend of composite device configurations (to cover unknown edge cases), geographic location, and other factors, for example. Patch delivery from the server's perspective is a simple download mechanism, such as the altered BitTorrent protocol, vanilla HTTPS, or other protocols.

The patch management system checks devices for any errors, initially for all devices receiving the image. As the download population grows, a random subset of the device population may be monitored for failures. Finally, comprehensive download stats may be provided for review.

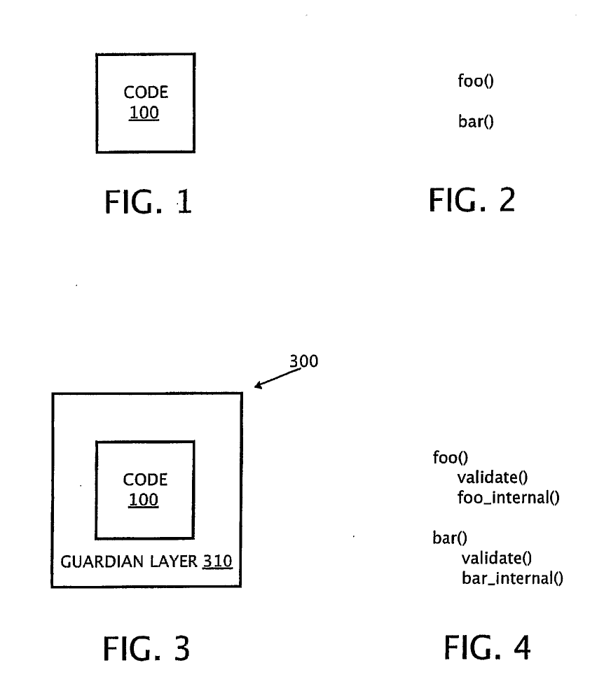

Various code modules or segments may be used in different embodiments. FIG. 1 illustrates an embodiment of a code module. Code module 100 includes software which may implement a function or a procedure, for example. Alternatively, code module 100 may be an object which implements a method or methods, for example. FIG. 2 illustrates an embodiment of a code API. The code API may include two functions without arguments, foo( ) and bar( ), for example. Thus, the code API of FIG. 2 may correspond to the code module 100, providing information about how to access the functionality of code module 100.

With a guardian layer involved, code segments take on a different approach. FIG. 3 illustrates an alternate embodiment of a code module. Code module 300 includes a guardian layer along with a more conventional code module. Code module 100 is a conventional code module, such as was illustrated in FIG. 1. Guardian layer 310 is an additional code component or module, which acts as a wrapper for code module 100. FIG. 4 illustrates an alternate embodiment of a code API such as may be used with code module 300. The API for code module 300 includes functions foo( ) and bar( ). Code module 100 in this instance provides foo_internal( ) and bar_internal( ) as software routines. However, foo( ) and bar( ) are the interface to the outside world. In addition to calling the corresponding routine in code module 100, the software routines of guardian layer 310 validate operation of the software overall. This can be accomplished by first validating any call to the routine before passing along the call to the internal routine.

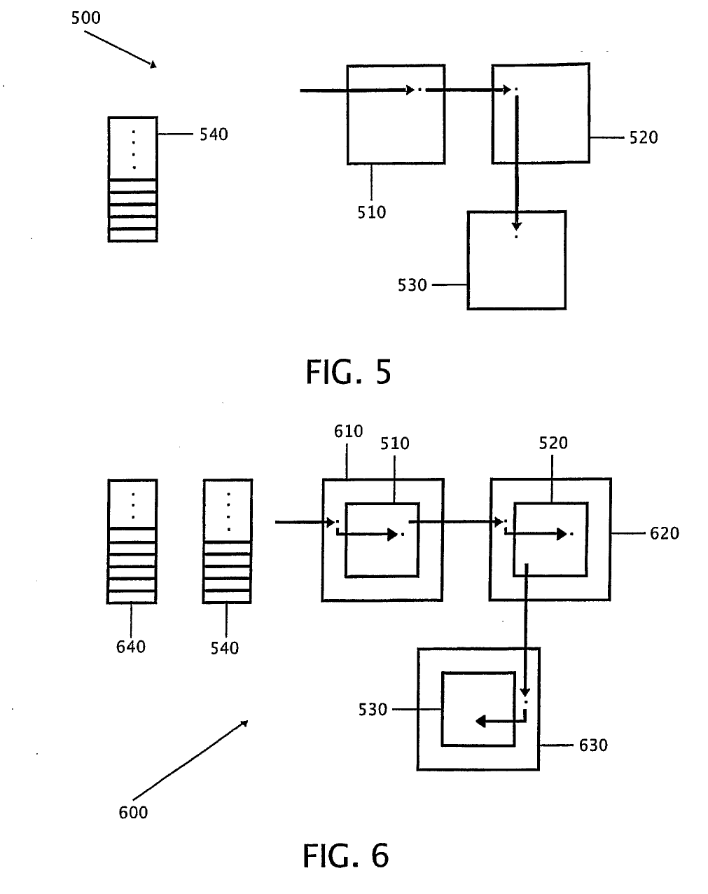

Reviewing an example of operation of software may be instructive. FIG. 5 illustrates an embodiment of a system of code segments. A set of code segments and a program stack is illustrated, along with calls between the segments. System 500 includes code segments 510, 520 and 530, along with program stack 540. As illustrated, a call is made to a routine in segment 510. Segment 510 executes a call to a routine in segment 520. Similarly, segment 520 executes a call to a routine in segment 530. Each of these calls may involve use of program stack 540 to store state information in a conventional system.

FIG. 6 illustrates an alternate embodiment of a system of code segments. Each of code segments 510, 520 and 530 have a guardian layer (610, 620, 630) associated therewith. Code transitions now occur through the intermediate mechanism of the guardian layer, rather than directly through the code segments. This allows for validation or authentication of code transitions, while still maintaining a modular approach to applications. Code transitions may include procedure calls, function calls or object method activations, for example.

One method of validation involves use of a separate guardian stack 640. Code segments using the system push status information on the guardian stack 640. This status information can then be used by a code segment (guardian layer) receiving a code transition to determine if the procedure or function call is coming from an authentic source. Status information can be as simple as an indication of where the call originates, or can be more involved, including information such as encrypted status information or separate identifying information, for example.

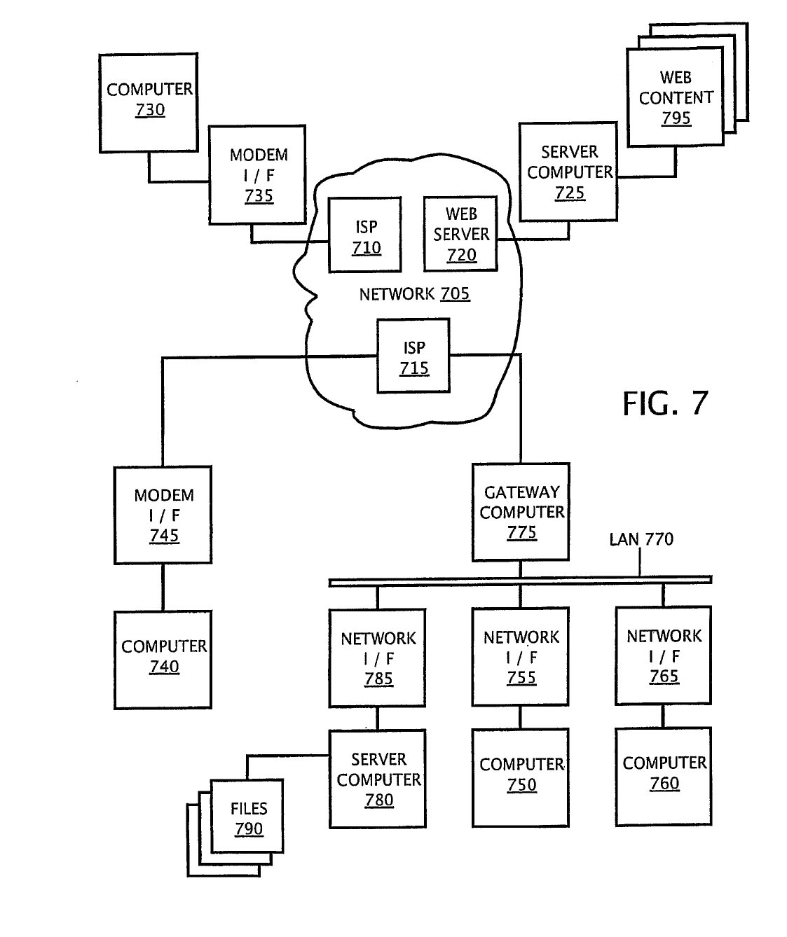

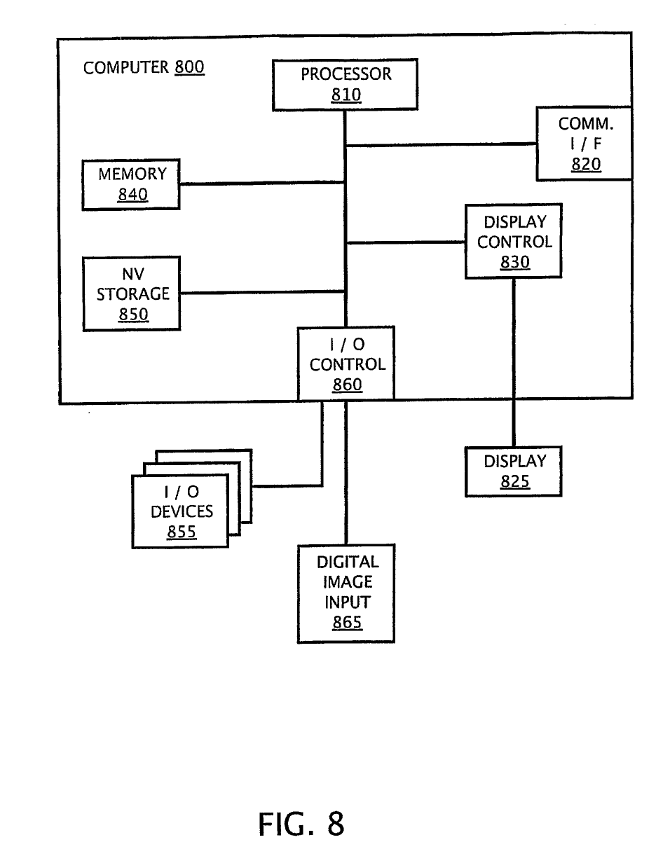

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows(r) from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

Various networks and machines such as those illustrated in FIGS. 7 and 8 may be utilized. Another type of network may be a cellular network.

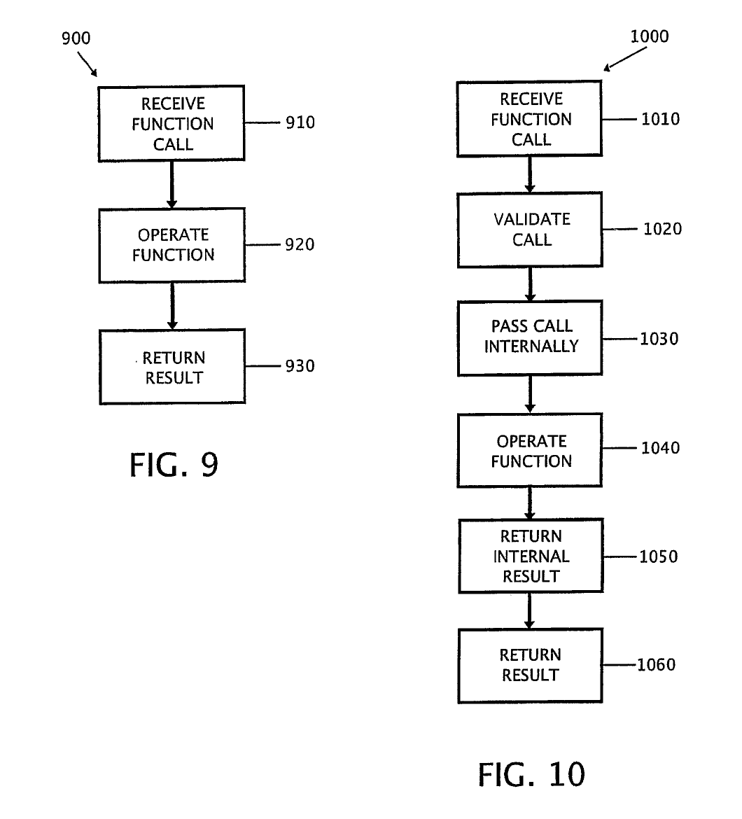

Code segments are executed on various types of device. FIG. 9 illustrates an embodiment of a process of executing a code segment. Process 900 includes receiving a function call, operating the function, and returning a result. Initially, a function is called at module 910. While a function call is referenced, other code transitions may also be appropriate, with or without a return result or parameter. Typically, some signal will indicate termination of execution of a code segment, even if a result is not returned. At module 920, the function or code segment is executed. At module 930, results of the function or code segment are returned or otherwise communicated to the calling code segment or process.

When a guardian layer is used with a code segment, the guardian layer may authenticate the process. FIG. 10 illustrates an alternate embodiment of a process of executing a code segment. Process 1000 illustrates use of a guardian layer in conjunction with a code segment. Process 1000 includes receiving a function call, validating the call, passing the call internally, operating the function, returning an internal result, and returning a result externally.

Process 1000 initiates with receipt of a function call or other activation of a code segment at module 1010. The function call is validated at module 1020, such as through an associated guardian stack. The function call is then passed internally to the code segment at module 1030. The function is then operated or executed at module 1040, producing a result, change in status, or side effect of some sort. At module 1050, the result is returned internally, such as from a code segment to a guardian layer or similar wrapper. The wrapper then returns the function result at module 1060.

Various embodiments of a process of authentication may be used.

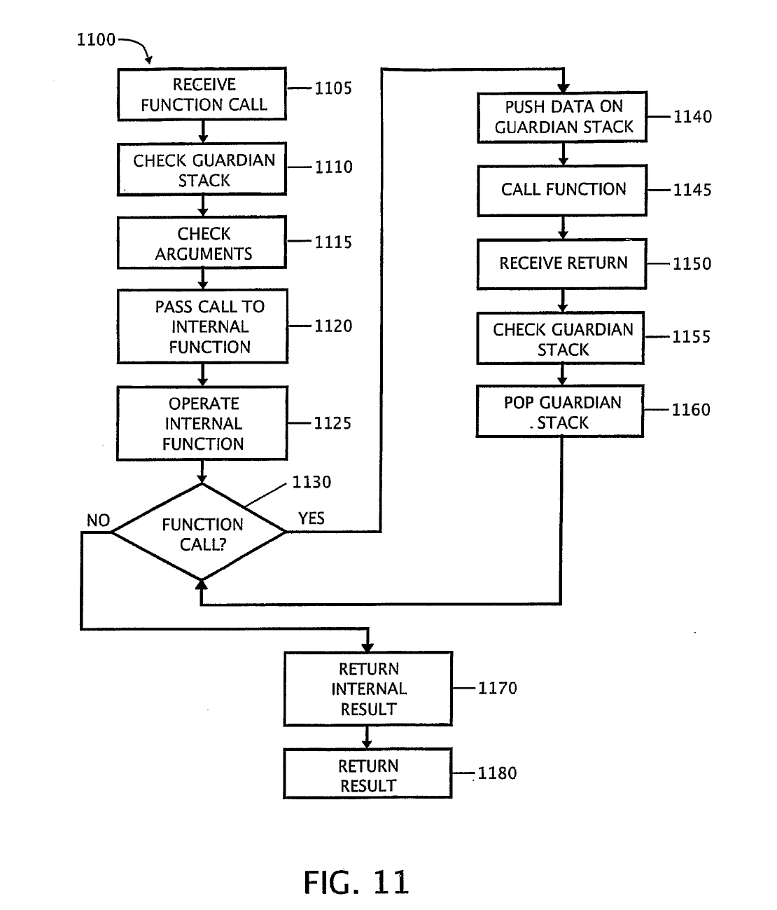

FIG. 11 illustrates an embodiment of a process of validating a code segment. Process 1100 illustrates an alternate embodiment of a process of operating a code segment and validating the process. Process 1100 includes receiving a function call, checking the function call, passing the call internally, operating the function, calling an additional function in conjunction with a guardian stack, receiving a return from the second function, and returning a result.

At module 1105, a function call or similar code transition is received. For illustrative purposes, this embodiment is described with reference to a function call. At module 1110, a guardian stack is checked for proper information. This may be as simple as checking for a proper originating address of a call, or may be much more involved. At module 1115, the arguments of the code transition are also checked as validated. At module 1120, the function call is passed to an internal function. At module 1125, the internal function is executed.

At module 1130, a determination is made as to whether a nested function call needs to occur. If so, then at module 1140, the present (internal) function pushes data on the guardian stack. At module 1145, the next function is called. At module 1150, the return result from the next function is received. At module 1155, the guardian stack is checked for proper information (such as unmodified data from the present function, or validated data from the present function, for example). At module 1160, the guardian stack is popped, removing information related to the present function from the guardian stack.

Eventually, the present (internal) function returns a result. This occurs at module 1170. This result is then returned by the guardian layer at module 1180 to whatever code segment called the function. Thereby, the overall purpose of the function is achieved. Note that whatever nested functions or other code segments are called will generally follow a similar process.

Authentication may be augmented by code tumblers. These are basically code operations that cross out into other modules, but can be completed in any sort of order. One may reorder the calls to a group of modules, in a random order. This can be chained several times to add more tumblers, so that it becomes a combination of tumblers for a bigger lock with only the true code programmed with the exact combination. Examination of a guardian stack can find traces of execution of these modules, and then remove these traces after authentication occurs. However, execution of the modules involved in a code tumbler out of order would leave a different set of traces on the guardian stack, indicating authentication should fail. An example of calls to a set of code tumbler modules is:

module foo

calls module bar

module bar

calls module bar_corge
calls module bar_grault
calls module bar_waldo

calls module baz
calls module qux

Basically, one may reorder the calls to bar, baz, and qux in a random order. Moreover, as mentioned above, this can be chained several times to add more tumblers. Thus, even if someone gets past other layers of defense the code tumbler provides another layer to defeat, while having a relatively minimal impact on performance.

As worms and other malicious code are persistent, one may parry attack after attack with the various layers, but the worm could over some time slip past the various guardian layers. To counter this type of statistical attack, a system may determine or trace what module was the original security hole into the device. An operating system may know what socket, therefore what origin IP address/port, and what port/service on the device was attacked successfully. A system can then block all traffic from that IP address or all traffic to that port based on a pre-programmed policy, for example. Such a policy can be extremely paranoid, triggering after a single attack for example, or it can be set to trigger after a predetermined threshold number of attempts from a certain number of addresses, for example. As worms can attack from many points simultaneously, such a threshold may be particularly effective. Other criteria beyond number of attacks may also be used.

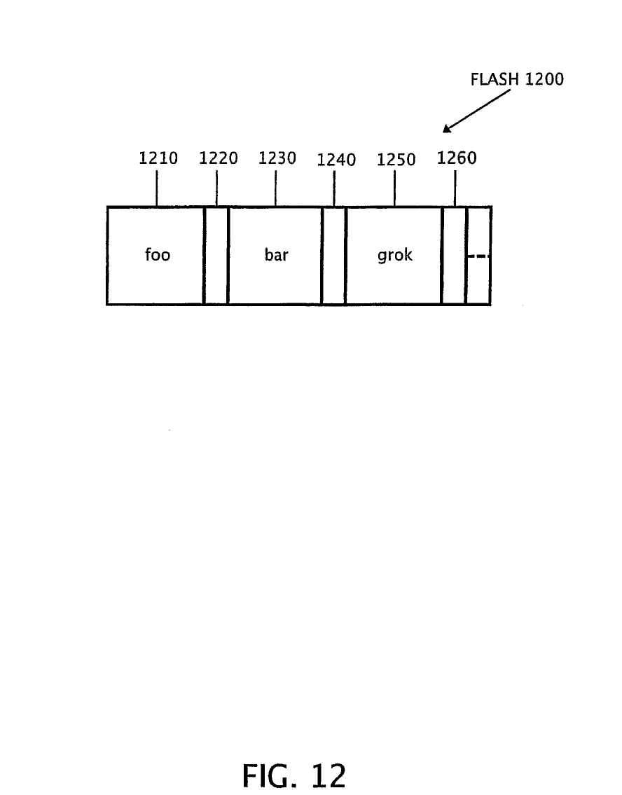

Patches with guardian layers may be embodied in various types of media. FIG. 12 illustrates an embodiment of a medium embodying patches. FLASH memory 1200 is illustrated. Other media may also be suitable in other embodiments. Memory 1200 includes code segments foo, bar and grok. Each of these code segments may be expected to provide a function, and to have an associated guardian layer. Thus, segment 1210 provides the foo( ) code, and segment 1220 provides a guardian layer for foo( ). Similarly, segment 1230 provides the bar( ) code, and segment 1240 provides a guardian layer for bar( ). Moreover, segment 1250 provides the grok( ) code, and segment 1260 provides a guardian layer for grok( ). Similarly arrangements of code may be used in other embodiments of a medium or media.

The wrappers illustrated may provide a layer of protection, but hackers may attempt to bypass screening for wrappers by adding a mock wrapper of their own. After adding a wrapper layer for the secondary stack, hackers will attempt to peer into the wrapper code to ascertain how they might be able to jump that piece of code in real-time, or simply use a hardwired address. To prevent this sort of leap over the wall attack, each wrapper function may have junk code at the start of the wrapper code which will be of random length and random in result to confuse any automated worm from attempting to sniff out the true and correct original address of an API. Thus, segment 1220, for example, may have a random set of code prepended to confuse an attack. Module order may also be in a random order to prevent the simple hardwired jump. Thus, segments 1210, 1220, 1230, 1240, 1250 and 1260 may be stored in random order, with internal consistency in addresses, but without making it apparent based on initial examination where code entry points exist.

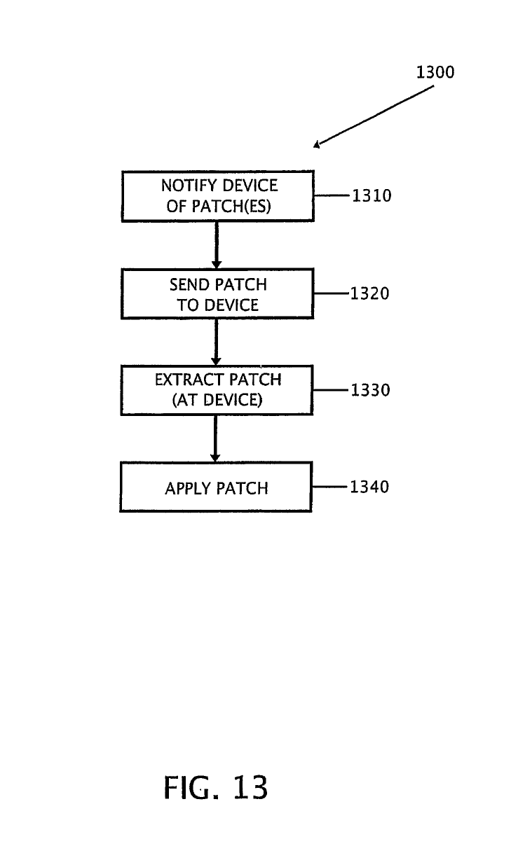

Similarly, a patch may be applied in a variety of ways. FIG. 13 illustrates an embodiment of a process of applying a patch. Process 1300 includes notifying a device of patches available, sending a patch to the device, extracting the patch at the device, and applying the patch. Process 1300 may be implemented at a server or control node within a network or coupled to a device, for example. The device is notified of available patches at module 1310. Thus may involve sending a message to the device, for example. At module 1320, a patch is sent to the device. At module 1330, the patch is extracted (at the device). This may involve a transaction for authentication data, for example, to verify that the patch is from a trusted source. The patch is then applied at module 1340.

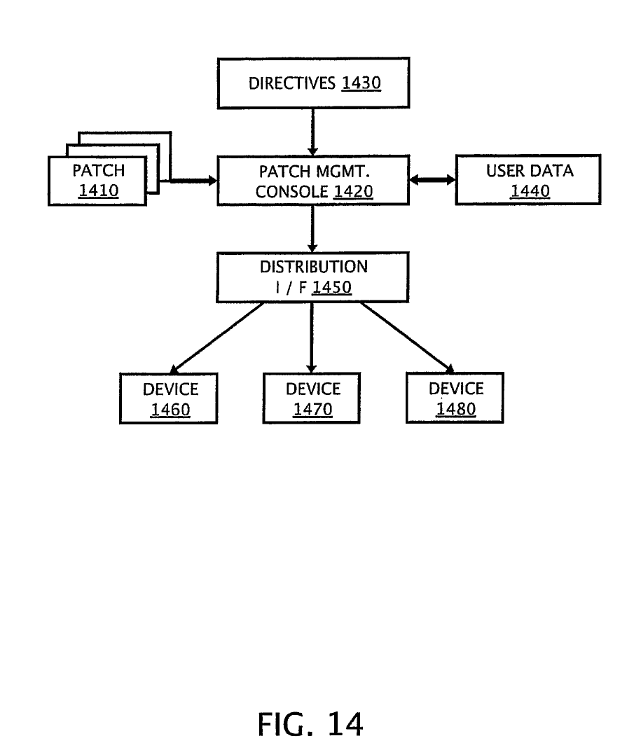

Moreover, a patch or patches may be managed by an overall system FIG. 14 illustrates an embodiment of a system for patch management. System 1400 provides a patch management console, associated patches, user profiles, overall directives, a distribution interface, and a variety of devices to receive the patches.

Patch management console 1420 works with a variety of patches 1410, each containing guardian layers for the various code segments therein. A set of directives 1430 provide an overall framework for how the patches 1410 should be distributed by the console 1420. Directives 1430 may be expressed as a set of rules, for example. Console 1420 also have available user data 1440, which allows specific devices or users to be matched against overall directives 1430. Console 1420 uses distribution interface 1450 to distribute patches according to the rules as applied to the users or devices. Thus, devices 1460, 1470 and 1480 may then receive patches.

Console 1420 may be directed to distribute certain patches 1410 only to certain users, or only to certain devices. Moreover, console 1420 may be used to monitor (by a user) how distribution of patches is progressing—such as when devices are only intermittently connected to a network, for example. Additionally, console 1420 may be used to change directives 1430 or user data 1440 as necessary.

Another option for maintaining security in software relates to tracking operation of the software. One may have software make a mark when it operates, providing information about where in the code the program or module was at a given time. These marks can then be observed and compared to normal operation of the software to determine if the code seems to be veering into unexpected territory (indicating the presence of foreign code such as malware). The marks made by code can be read as a series of notes, and compared to a similar series to determine if the code appears to be playing the expected tune (operating correctly) or if something is making the code play offkey or out of rhythm (suggesting malware).

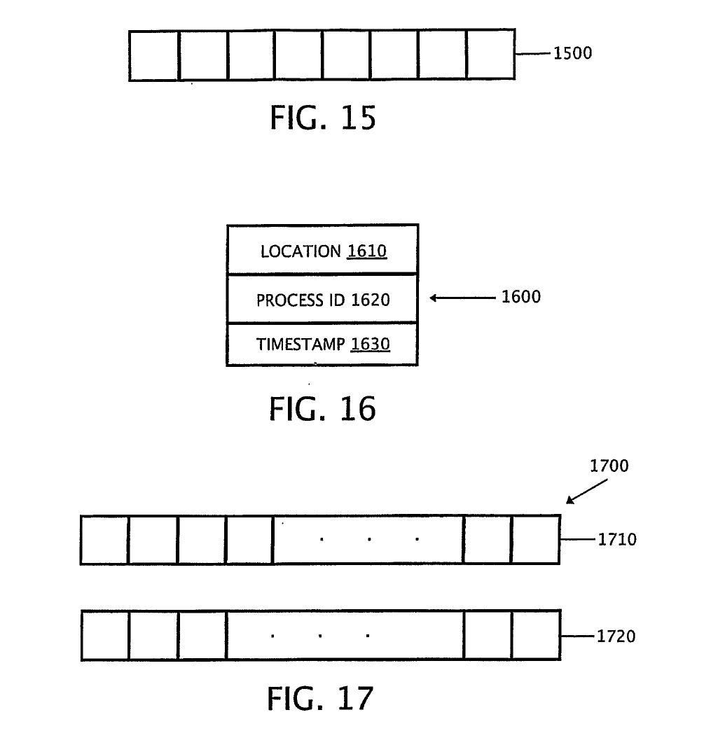

FIG. 15 illustrates an embodiment of a circular buffer which may be used in tracking code progress. Buffer 1500 represents an array of data structures. Each data structure may than include information about status of a process. With a pointer to the first entry in the buffer 1500, the buffer 1500 may then be used in a circular fashion. Note that the length of the circular buffer 1500 may be controlled to determine the depth at which code operation is analysed (how far back the history goes).

Various data structures may be used with buffer 1500. FIG. 16 illustrates an embodiment of a data structure of entries which may be used in tracking code progress. Data structure 1600 provides fields to store a location 1610, process id 1620 and timestamp 1630. Thus, data structure 1600 can provide a mark or pointer into a routine, indicating where in a module's code the process was at a given time. In some embodiments, code can be seeded with calls to a mark routine which records a program counter or similar value, a timestamp, and a process identifier into a data structure 1600 within a circular buffer.

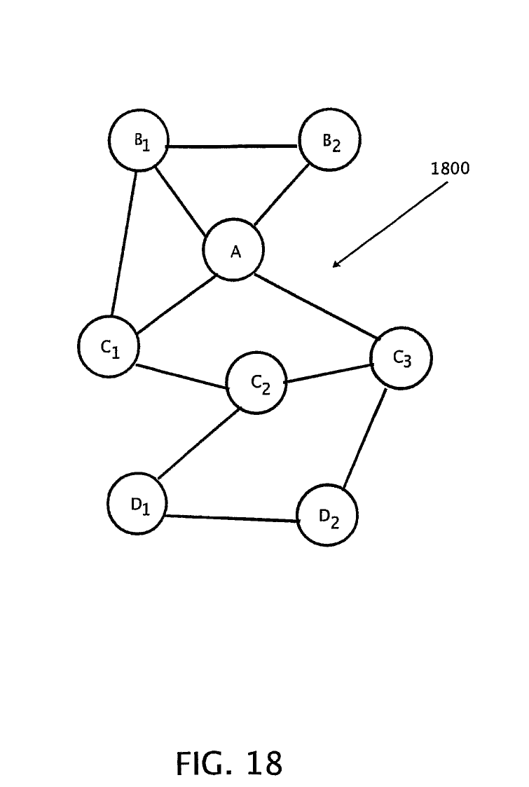

While the data structures of FIG. 16 are useful for tracking code in a single buffer, it may be necessary to track code across multiple contexts or otherwise track different modules in parallel. FIG. 17 illustrates an embodiment of a set of circular buffers which may be used in tracking code progress. Set 1700 is illustrated to include two buffers 1710 and 1720, each of which may be made up of data structures such as data structure 1600. In an embodiment, buffer 1710 is used to track code in a first context (e.g. an operating system) and buffer 1720 is used to track code in a second context (e.g. an application).

With a circular buffer in place, one must compare the operation of the code to a reference. FIG. 18 illustrates an embodiment of a graph of software code. The graph provides all paths the software can take (or all paths it can legally take). It can be created by running the software using simulation or test cases, or it can be created by analyzing the software in much the same way that compilation and linkage analyzes software.

Thus, graph 1800 illustrates a graph of a program or module using routines A, B, C and D. Each node of the graph represents a mark point within a routine—a point where a mark procedure/function call has been inserted. The edges of the graph represent permissible transitions. Thus, one may attempt to traverse the graph 1800 in the manner dictated by the contents of a circular buffer 1500, comparing timestamps differentials to expected differentials between nodes. If the time differential seems too great or small, this can indicate an error. Note that a tolerance for time differential may be included in the graph 1800 in some embodiments, or a tolerance may be predetermined. If a transition in the buffer 1500 was not allowed based on the graph 1800, this indicates another type of error.

Graph 1800 may be generated locally on a device in some instances. This allows for updated software to be taken into account. Alternatively, the graph 1800 may be generated as part of the software development process. In such an instance, local device resources would not be required for graph generation during or after an update.

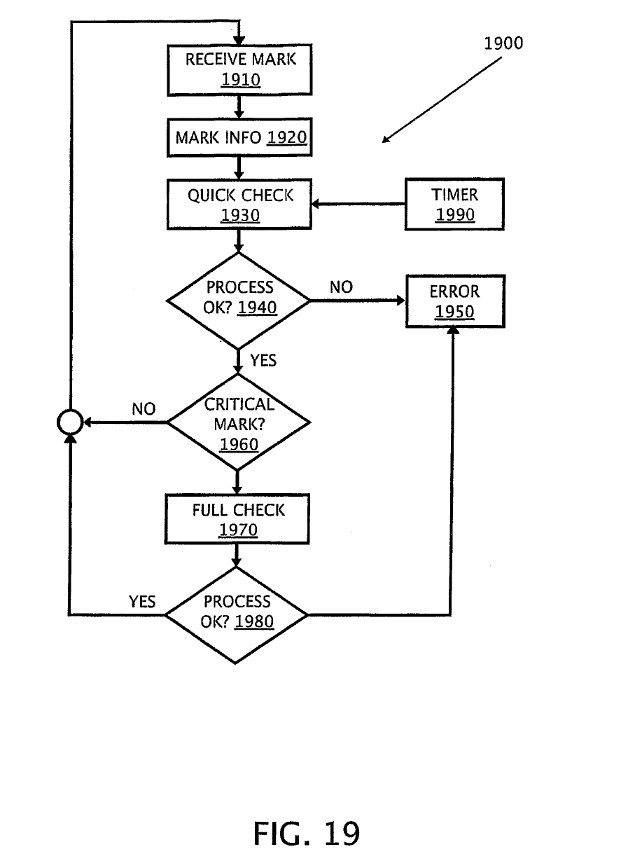

The process by which marks occur and a comparison is made can be implemented in a variety of ways. FIG. 19 illustrates an embodiment of a process of tracking code using circular buffers. Process 1900 includes receiving a mark (call), marking information, performing a quick check, determining if the process is ok, determining a mark is critical, performing a fill check and signaling an error if necessary.

At module 1910, a mark is received, such as through a mark function call from a routine. At module 1920, the mark information is recorded. At module 1930, a quick check is made to determine if the mark is reasonable. This may be as simple as checking the mark and a preceding mark against a graph, or may be more involved. For example, module 1930 may make use of a timer 1990 (such as a system clock or separate timer for example). If the process is operating normally, at module 1940, a determination is made to move forward. If not, an error may be signaled at module 1950.

If the mark is a critical mark, this is determined at module 1960. A critical mark may be indicated by a parameter in a mark function call, or may be based on a predetermined number of marks being registered, for example. If the makr is critical, then a fill check may be performed at module 1970. The fill check may involve evaluating all parameters marked (recorded) against the graph, rather than just looking at transitions, for example. If the process is determined at module 1980 to be showing either times out of tolerance or illegal transitions, an error may be signaled at module 1950. If the process is ok, either at module 1960 or 1980, the process returns to module 1910 for the next mark.

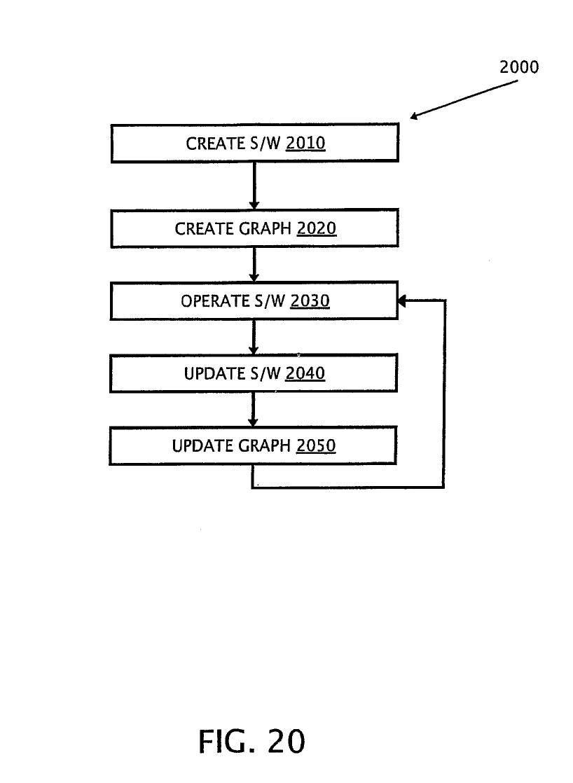

With software changing dynamically, creating and maintaining the graph for such a system becomes important. FIG. 20 illustrates an embodiment of a process of maintaining and using a graph of software code. Process 2000 includes creating software, creating an associated graph, operating the software, updating the software, and updating the graph.

Process 2000 begins with creation of software at module 2010. After the software is created (e.g. programmed), a graph is created at module 2020. The graph may be created through simulation, software quality assurance, or automated analysis of the software. At module 2030, the software is operated, such as by a customer. This includes marking and checking marks against the graph of module 2020. At module 2040, an update to the software is propagated or received. This involves a correspondingly updated graph (generally), which is provided at module 2050. Thus, the software can accommodate changes while still allowing for integrity checks and security against malware.

From the foregoing, it will be appreciated that specific embodiments of the invention have been described herein for purposes of illustration, but that various modifications may be made without deviating from the spirit and scope of the invention. In some instances, reference has been made to characteristics likely to be present in various or some embodiments, but these characteristics are also not necessarily limiting on the spirit and scope of the invention. In the illustrations and description, structures have been provided which may be formed or assembled in other ways within the spirit and scope of the invention. Moreover, in general, features from one embodiment may be used with other embodiments mentioned in this document provided the features are not somehow mutually exclusive.

In particular, the separate modules of the various block diagrams represent functional modules of methods or apparatuses and are not necessarily indicative of physical or logical separations or of an order of operation inherent in the spirit and scope of the present invention. Similarly, methods have been illustrated and described as linear processes, but such methods may have operations reordered or implemented in parallel within the spirit and scope of the invention.

What is claimed is:

1. A method, comprising:
receiving a call to a code module;
checking a guardian stack for indications of authorization, the guardian stack separate from an execution stack;
passing the call to an internal code module; and
executing the code module.

2. The method of claim 1, further comprising:
validating the call to the code module based on the indications of authorization.

3. The method of claim 1, further comprising:
blocking a call to a code module based on incorrect indications of authorization.

4. The method of claim 1, further comprising:
returning a result of executing the code module.

5. The method of claim 4, further comprising:
returning an internal result from the internal code module; and
providing the internal result as the result.

6. The method of claim 1, further comprising:
checking arguments to the code module.

7. The method of claim 1, further comprising:
marking a mark queue responsive to a mark instruction of the internal code module.

8. The method of claim 7, further comprising:
checking the mark queue for marks based on expected mark instructions.

9. The method of claim 8, further comprising:
signaling an error responsive to an incorrect entry in the mark queue.

10. The method of claim 8, further comprising:
checking the mark queue responsive to a timer.

11. The method of claim 8, wherein:
the expected mark instructions are stored as a graph.

12. A machine-readable medium, embodying instructions, the instructions, when executed, causing a processor to perform a method, the method comprising:
receiving a call to a code module;
checking a guardian stack for indications of authorization, the guardian stack separate from an execution stack;
passing the call to an internal code module; and
executing the code module.

13. The machine-readable medium of claim 12, wherein:
the machine-readable medium embodies a patch to a software system, the patch including the instructions which execute the method.

14. The machine-readable medium of claim 13, wherein:
the patch may be distributed to receiving devices for incorporation into a software system of the receiving devices.

15. The machine-readable medium of claim 12, wherein the method further comprises:
checking arguments to the code module;
validating the call to the code module based on the indications of authorization;
returning an internal result from the internal code module;
providing the internal result as a result of executing the code module; and
returning the result of executing the code module.

16. The machine-readable medium of claim 12, wherein the method further comprises:
marking a mark queue responsive to a mark instruction of the internal code module; and
checking the mark queue for marks based on expected mark instructions.

17. A system, comprising:
a processor;
a memory coupled to the processor;
a user interface coupled to the processor;
a network interface coupled to the processor;
wherein the processor is to:
receive a call to a code module;
check a guardian stack for indications of authorization, the guardian stack separate from an execution stack;
pass the call to an internal code module; and
execute the internal code module.

18. The system of claim 17, wherein the processor is further to:
check arguments to the code module;
validate the call to the code module based on the indications of authorization;
return an internal result from the internal code module;
provide the internal result as a result of executing the code module; and
return the result of executing the code module.

19. The system of claim 17, wherein the processor is further to:
mark a mark queue responsive to a mark instruction of the internal code module; and
check the mark queue for marks based on expected mark instructions.

20. The system of claim 17, further comprising:
means for storing data in a non-volatile manner.
